(19) United States
(12) Patent Application Publication
(10) Pub. No.: US 2019/0286144 A1
(43) Pub. Date: Sep. 19, 2019

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Naoto Yasuda, Wako-shi (JP); Takafumi Hirose, Wako-shi (JP); Yuki Oshitani, Tokyo (JP); Susumu Iwamoto, Tokyo (JP)

(21) Appl. No.: 16/293,681

(22) Filed: Mar. 6, 2019

(30) Foreign Application Priority Data
Mar. 16, 2018 (JP) 2018-049191

(51) Int. Cl. G05D 1/02; G07C 5/08; G07C 5/00

(52) U.S. Cl. CPC G05D 1/021; G05D 2201/0212; G07C 5/008; G07C 5/0808

(57) ABSTRACT

A vehicle control device (100) includes a detection unit (132) configured to detect an abnormal factor occurring in an own vehicle capable of performing automatic driving, and a control unit (180, 190) configured to supply information for recovering the own vehicle from the abnormal factor to the outside of the own vehicle in a case that the own vehicle stops due to the abnormal factor detected by the detection unit.

### CROSS-REFERENCE TO RELATED APPLICATION

Priority is claimed on Japanese Patent Application No. 2018-049191, filed Mar. 16, 2018, the content of which is incorporated herein by reference.

### BACKGROUND

### Field of the Invention

The present invention relates to a vehicle control device, a vehicle control method, and a storage medium.

### Description of Related Art

In recent years, studies for automatically controlling vehicles have been conducted. With regard to this, a technology for sharing information regarding vehicles between an own vehicle and other vehicles is known (for example, see Japanese Unexamined Patent Application, First Publication No. 2017-146657).

### SUMMARY

However, the technology of the related art does not solve abnormality occurring in an own vehicle on the spot. Therefore, in a case that a sensor becomes dirty with mud in an unmanned automatic driving vehicle in which no occupant boards, there is a problem of a driving incapability state even in an abnormal state in which the abnormality can be solved in a case that the mud is cleared on the spot.

An aspect of the present invention has been realized in view of such circumstances and an object of the present invention is to provide a vehicle control device, a vehicle control method, and a storage medium capable of performing assistance to solve a stop state in a case that an unmanned automatic driving vehicle stops due to some kind of factor.

The vehicle control device, the vehicle control method, and the storage medium according to the present invention adopt the following configurations.

(1) According to an aspect of the present invention, there is provided a vehicle control device including: a detection unit that is configured to detect an abnormal factor occurring in an own vehicle capable of performing automatic driving; and a control unit that is configured to supply information for recovering the own vehicle from the abnormal factor to an outside of the own vehicle in a case that the own vehicle stops due to the abnormal factor detected by the detection unit.

(2) In the forgoing (1) aspect, the control unit may stop supplying the information in a case that the abnormal factor is solved.

(3) In the forgoing (1) aspect, the control unit may supply the information to a terminal device around the own vehicle via a communication unit.

(4) In the forgoing (1) aspect, the control unit may communicate with a server set to supply the information of the own vehicle to a third party via a communication unit and supply the information to the server.

(5) In the forgoing (1) aspect, the control unit may communicate with a server set to supply countermeasure information for the abnormal factor occurring in the own vehicle via a communication unit and supply the countermeasure information to the server.

(6) In the forgoing (1) aspect, the control unit may supply the information using a display unit that displays information to a periphery of the own vehicle.

(7) In the forgoing (1) aspect, the own vehicle may be an unmanned automatic driving vehicle.

(8) According to another aspect of the invention, there is provided a vehicle control method performed by a computer mounted on a vehicle control device. The method includes: by the vehicle control device, detecting an abnormal factor occurring in an own vehicle capable of performing automatic driving; and supplying information for recovering the own vehicle from the abnormal factor to an outside of the own vehicle in a case that the own vehicle stops due to the abnormal factor detected by the vehicle control device.

(9) According to still another aspect of the invention, there is provided a computer-readable non-transitory storage medium storing a program and causing a computer mounted on a vehicle control device to: detect an abnormal factor occurring in an own vehicle capable of performing automatic driving; and supply information for recovering the own vehicle from the abnormal factor to an outside of the own vehicle in a case that the own vehicle stops due to the abnormal factor detected by the vehicle control device.

According to the foregoing (1) to (8) and (9) aspects, it is possible to perform assistance to solve a stop state in a case that an unmanned automatic driving vehicle stops due to some kind of factor.

According to the foregoing (3), (4), and (5) aspects, it is possible to supply a third party with information regarding the factor causing the own vehicle to stop, so that traffic can be facilitated.

According to the foregoing (6) aspect, it is possible to supply the periphery of the own vehicle with information regarding the factor causing the own vehicle to stop so that traffic can be facilitated.

### BRIEF DESCRIPTION OF THE DRAWINGS

FIG. 1 is a diagram showing a configuration of a vehicle system 1 in which a vehicle control device is used according to an embodiment.

FIG. 2 is a diagram showing a functional configuration of a first control unit 120 and a second control unit 160.

FIG. 3 is a diagram showing an example of content of recovery information R.

FIG. 4 is a diagram showing an example of content of display information D displayed on a display unit during stopping of an own vehicle M.

FIG. 5 is a diagram showing abnormality detected by a vehicle state detection unit 132.

FIG. 6 is a diagram showing an example of content of control information G generated by the vehicle state detection unit 132.

FIG. 7 is a diagram showing an example of content of a display image IM2 displayed on a terminal device P.

FIG. 8 is a flowchart showing an example of a flow of a process performed in an automatic driving control device 100.

FIG. 9 is a diagram showing an example of a hardware configuration of the automatic driving control device 100 according to an embodiment.

### DESCRIPTION OF EMBODIMENTS

Hereinafter, embodiments of a vehicle control device, a vehicle control method, and a storage medium according to the present invention will be described with reference to the drawings. Hereinafter, a case in which left-hand traffic regulations are applied will be described. In a case that right-hand traffic regulations are applied, the right and left may be switched.

### [Overall Configuration]

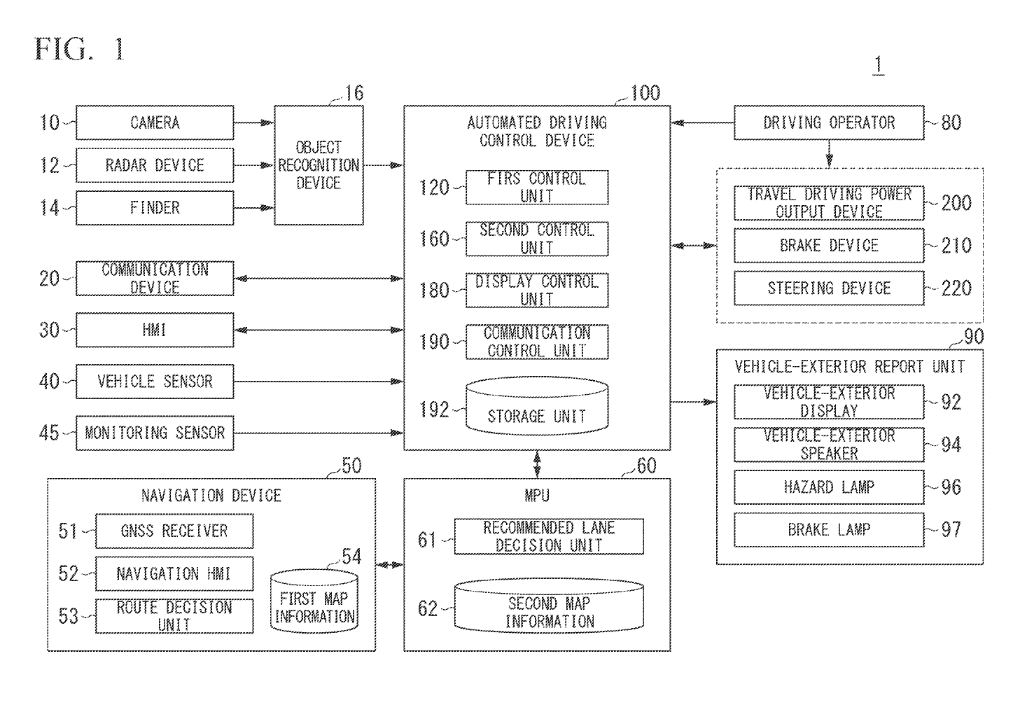

FIG. 1 is a diagram showing a configuration of a vehicle system 1 in which a vehicle control device is used according to an embodiment. A vehicle in which the vehicle system 1 is mounted is, for example, a vehicle such as a two-wheeled vehicle, a three-wheeled vehicle, or a four-wheeled vehicle. A driving source of the vehicle includes an internal combustion engine such as a diesel engine or a gasoline engine, an electric motor, and a combination thereof. The electric motor operates using power generated by a power generator connected to the internal combustion engine or power discharged from a secondary cell or a fuel cell.

The vehicle system 1 includes, for example, a camera 10, a radar device 12, a finder 14, an object recognition device 16, a communication device 20, a human machine interface (HMI) 30, a vehicle sensor 40, a navigation device 50, a map positioning unit (MPU) 60, a driving operator 80, an automatic driving control device 100, a travel driving power output device 200, a brake device 210, and a steering device 220. The devices and units are connected to each other via a multiplex communication line such as a controller area network (CAN) communication line, a serial communication line, or a wireless communication network. The configuration shown in FIG. 1 is merely exemplary, a part of the configuration may be omitted, and another configuration may be further added.

The camera 10 is, for example, a digital camera that uses a solid-state image sensor such as a charged coupled device (CCD) or a complementary metal oxide semiconductor (CMOS). The camera 10 is mounted on any portion of the vehicle in which the vehicle system 1 is mounted (hereinafter referred to as an own vehicle M). In the case of forward imaging, the camera 10 is mounted on an upper portion of a front windshield, a rear surface of a rearview mirror, or the like. For example, the camera 10 repeatedly images the periphery of the own vehicle M periodically. The camera 10 may be a stereo camera.

The radar device 12 radiates radio waves such as millimeter waves to the periphery of the own vehicle M and detects radio waves (reflected waves) reflected from an object to detect at least a position (a distance and an azimuth) of the object. The radar device 12 is mounted on any portion of the own vehicle M. The radar device 12 may detect a position and a speed of an object in conformity with a frequency modulated continuous wave (FM-CW) scheme.

The finder 14 is a light detection and ranging (LIDAR) finder. The finder 14 emits light to the periphery of the own vehicle M and measures scattered light. The finder 14 detects a distance to a target based on a time from light emission to light reception. The emitted light is, for example, a pulsed laser beam. The finder 14 is mounted on any portion of the own vehicle M.

The object recognition device 16 performs a sensor fusion process on detection results from some or all of the camera 10, the radar device 12, and the finder 14 and recognizes a position, a type, a speed, and the like of an object. The object recognition device 16 outputs a recognition result to the automatic driving control device 100. The object recognition device 16 may output the detection results of the camera 10, the radar device 12, and the finder 14 without change to the automatic driving control device 100. The object recognition device 16 may be omitted from the vehicle system 1.

The communication device 20 communicates with other vehicles around the own vehicle M using, for example, a cellular network, a Wi-Fi network, Bluetooth (registered trademark), dedicated short range communication (DSRC), or the like or communicates with various server devices via wireless base stations.

The HMI 30 suggests various types of information to occupants of the own vehicle M and receives input operations by the occupants. The HMI 30 includes various display devices, speakers, buzzers, touch panels, switches, and keys.

The vehicle sensor 40 includes a vehicle speed sensor that detects a speed of the own vehicle M, an acceleration sensor that detects acceleration, a yaw rate sensor that detects an angular velocity around a vertical axis, and an azimuth sensor that detects a direction of the own vehicle M.

A monitoring sensor 45 is a self-diagnostic sensor that detects abnormality of devices included in the own vehicle M. The monitoring sensor 45 is a sensor disposed in each device such as the travel driving power output device 200, the brake device 210, the steering device 220, an exhaust device, an exhaust catalyst, lights, and an air conditioner. The monitoring sensor 45 delivers a conductive state of each device to an output destination, for example, by detecting a monitoring current value conducted to each device.

The monitoring sensor 45 may detect an operation state of the device itself. The monitoring sensor 45 is an angle rotation sensor of a motor, a temperature sensor of a battery, a sensor that detects a control signal line state, or the like.

The navigation device 50 includes, for example, a global navigation satellite system (GNSS) receiver 51, a navigation HMI 52, and a route decision unit 53. The navigation device 50 retains first map information 54 in a storage device such as a hard disk drive (HDD) or a flash memory. The GNSS receiver 51 specifies a position of the own vehicle M based on signals received from GNSS satellites. The position of the own vehicle M may be specified or complemented by an inertial navigation system (INS) using an output of the vehicle sensor 40. The navigation HMI 52 includes a display device, a speaker, a touch panel, and a key. The navigation HMI 52 may be partially or entirely the same as to the above-described HMI 30. The route decision unit 53 decides, for example, a route from a position of the own vehicle M specified by the GNSS receiver 51 (or any input position) to a destination input by an occupant using the navigation HMI 52 (hereinafter referred to as a map route) with reference to the first map information 54. The first map information 54 is, for example, information in which a road form is expressed by links indicating roads and nodes connected by the links. The first map information 54 may include curvatures of roads and point of interest (POI) information.

The map route is output to the MPU 60. The navigation device 50 may perform route guidance using the navigation HMI 52 based on a map route. The navigation device 50 may be realized by, for example, a function of a terminal device such as a smartphone or a tablet terminal possessed by the occupant. The navigation device 50 may transmit a current position and a destination to a navigation server via the communication device 20 to acquire the same route as a map route from the navigation server.

The MPU 60 includes, for example, a recommended lane decision unit 61 and retains second map information 62 in a storage device such as an HDD or a flash memory. The recommended lane decision unit 61 divides a map route provided from the navigation device 50 into a plurality of blocks (for example, divides the map route in a vehicle travel direction every 100 [m]) and decides a recommended lane for each block with reference to the second map information 62. The recommended lane decision unit 61 decides in which lane the own vehicle M travels from the left. In a case that there is a branching spot on a map route, the recommended lane decision unit 61 decides a recommended lane so that the own vehicle M can travel along a reasonable route for traveling to a branching destination.

The second map information 62 is map information with higher precision than the first map information 54. The second map information 62 includes, for example, information regarding the middles of lanes or information regarding boundaries of lanes. The second map information 62 may include road information, traffic regulation information, address information (address and postal number), facility information, and telephone number information. The second map information 62 may be updated frequently in a case that the communication device 20 communicates with another device.

The driving operator 80 includes, for example, an accelerator pedal, a brake pedal, a shift lever, a steering wheel, a steering variant, a joystick, and other operators.

A sensor that detects whether there is an operation or an operation amount is mounted on the driving operator 80. A detection result is output to the automatic driving control device 100 or some or all of the travel driving power output device 200, the brake device 210, and the steering device 220.

A vehicle-exterior report unit 90 includes, for example, a vehicle-exterior display 92, a vehicle-exterior speaker 94, a hazard lamp 96, and a brake lamp 97. The vehicle-exterior display 92 is, for example, a transmission type liquid crystal panel formed in at least a part of the front windshield, a side windshield, or a rear windshield of the own vehicle M. The vehicle-exterior display 92 may be, for example, an organic electro-luminescence (EL) display adhered to the surface of the external body of the own vehicle M. The vehicle-exterior display 92 may be a liquid crystal display (LCD) fitted in the body or may be a display panel that serves as a part or the whole of the body. The vehicle-exterior display 92 displays, for example, a predetermined image or an animation image under the control of a display control unit 180 to be described below. The vehicle-exterior display 92 is an example of a “display unit” and displays information to the periphery of the own vehicle M.

The vehicle-exterior speaker 94 outputs, for example, a predetermined sound to the periphery of the own vehicle M under the control of the display control unit 180. The hazard lamp 96 blinks a lamp disposed in each of the front, rear, right, and left of the body of the own vehicle M, for example, under the control of the display control unit 180 or through a switch operation by an occupant. The brake lamp 97 lights in tandem with an operation of a brake pedal in a normal driving state to report an operation of the brake device 210 to the periphery of the own vehicle M.

The brake lamp 97 performs blinking display under the control of the display control unit 180, for example, in a case that the hazard lamp 96 does not operate, and thus is used as a substitute for the hazard lamp 96.

A combination of the communication device 20 and the vehicle-exterior report unit 90 is an example of a “report unit.”

The automatic driving control device 100 (a vehicle control device) includes, for example, a first control unit 120, a second control unit 160, a display control unit 180, a communication control unit 190, and a storage unit 192. Each of the first control unit 120, the second control unit 160, the display control unit 180, and the communication control unit 190 is realized, for example, by causing a hardware processor such as a central processing unit (CPU) to execute a program (software). Some or all of these constituent elements may be realized by hardware (a circuit unit including circuitry) such as a large scale integration (LSI), an application specific integrated circuit (ASIC), a field-programmable gate array (FPGA), or a graphics processing unit (GPU) or may be realized by software and hardware in cooperation. The program may be stored in advance in a storage device such as an HDD or a flash memory of the automatic driving control device 100 or may be stored in a removable storage medium such as a DVD or a CD-ROM to be installed in the HDD or the flash memory of the automatic driving control device 100 in a case that the storage medium is mounted in the drive device. A combination of the display control unit 180 and the communication control unit 190 is an example of a “control unit” and a combination of the communication control unit 190 and the communication device 20 is an example of a “communication unit.”

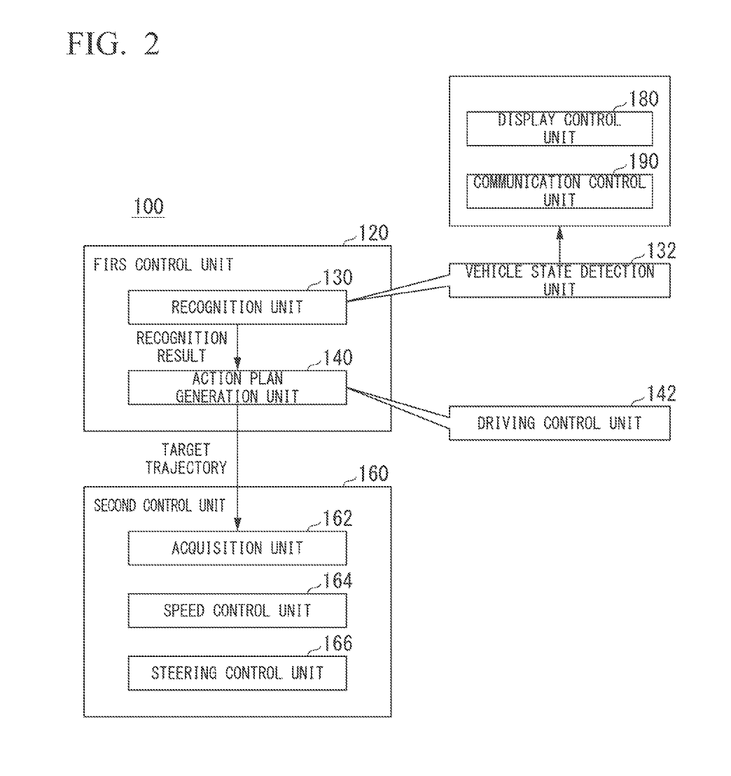

FIG. 2 is a diagram showing a functional configuration of the first control unit 120 and the second control unit 160. The first control unit 120 includes, for example, a recognition unit 130 and an action plan generation unit 140. The first control unit 120 concurrently realizes, for example, a function using artificial intelligence (AI) and a function using a pre-given model. For example, an “intersection recognition” function may be realized by concurrently performing recognition of an intersection by deep learning or the like and recognition based on a pre-given condition (there is a sign, a road sign, and the like for which pattern matching is possible) and scoring both for comprehensive evaluation. In this way, reliability of automatic driving is guaranteed.

The recognition unit 130 recognizes states such as a position, a speed, and acceleration of objects around the own vehicle M based on information input from the camera 10, the radar device 12, and the finder 14 via the object recognition device 16. The position of an object is recognized as, for example, a position on absolute coordinates in which a representative point (the center of gravity, a center of a driving shaft, or the like) of the own vehicle M is set as the origin and is used for control. The position of an object may be expressed as a representative point of the center of gravity, a corner, or the like of the object or may be represented in an expressed region. A “state” of an object may include acceleration or jerk of the object or an “action state” (for example, whether to change a lane or attempt to change a lane).

For example, the recognition unit 130 recognizes a lane (traveling lane) in which the own vehicle M is traveling. For example, the recognition unit 130 recognizes a traveling lane by comparing patterns of road mark lines (for example, arrangement of continuous lines and broken lines) obtained from the second map information 62 with patterns of road mark lines around the own vehicle M recognized from images captured by the camera 10. The recognition unit 130 may recognize a traveling lane by mainly recognizing boundaries (road boundaries) including road mark lines or shoulders, curbstones, median strips, and guardrails without being limited to road mark lines. In this recognition, the position of the own vehicle M acquired from navigation device 50 or a process result by INS may be added. The recognition unit 130 recognizes temporary stop lines, obstacles, red signals, toll gates, other road events.

The recognition unit 130 recognizes a position or an attitude of the own vehicle M with respect to the traveling lane in a case that the recognition unit 130 recognizes the traveling lane. For example, the recognition unit 130 may recognize a separation from the middle of a lane of a reference point of the own vehicle M and an angle formed with a line extending along the middle of a lane in the traveling direction of the own vehicle M as a relative position and attitude of the own vehicle M to the traveling lane. Instead of this, the recognition unit 130 may recognize a position or the like of the reference point of the own vehicle M with respect to a side end portion (a road mark line or a road boundary) of any traveling lane as the relative position of the own vehicle M to the traveling lane. The recognition unit 130 recognizes a collision of the own vehicle M with an object. The recognition unit 130 recognizes that a failure handling person arrives in a state in which the own vehicle M waits on a road.

The recognition unit 130 includes a vehicle state detection unit 132. For example, the vehicle state detection unit 132 monitors devices included in the own vehicle M based on detection results of the monitoring sensor 45 and detects failures occurring in the own vehicle M. The details of the vehicle state detection unit 132 will be described later.

In principle, the action plan generation unit 140 travels along a recommended lane decided by the recommended lane decision unit 61 and further generates a target trajectory along which the own vehicle M travels in future automatically (independently from an operation of a driver or the like) to handles a surrounding situation of the own vehicle M. The target trajectory includes, for example, a speed component. For example, the target trajectory is expressed by sequentially arranging spots (trajectory points) at which the own vehicle M arrives. The trajectory point is a spot at which the own vehicle M arrives for each predetermined travel distance (for example, about several [m]) by a distance along a road. Apart from this, target speed and target acceleration at each predetermined sampling time (for example, about 0 decimal point [sec]) are generated as a part of the target trajectory. The trajectory point may be a position at which the own vehicle M arrives at the sampling time for each predetermined sampling time. In this case, information regarding the target speed or the target acceleration is expressed at intervals of the trajectory point.

The action plan generation unit 140 may set an automatic driving event in a case that the target trajectory is generated. As the automatic driving event, there are a constant speed traveling event, a low speed track traveling event, a lane changing event, a branching event, a joining event, a takeover event, an evacuation event, and the like. The action plan generation unit 140 generates the target trajectory in accordance with an activated event. The action plan generation unit 140 includes a driving control unit 142. For example, in a case that a failure of the own vehicle M itself is detected based on a detection result of the vehicle state detection unit 132, the driving control unit 142 moves the own vehicle M to a region in which the flow of traffic is not interrupted. The details of a process of the driving control unit 142 will be described later.

The second control unit 160 controls the travel driving power output device 200, the brake device 210, and the steering device 220 so that the own vehicle M passes along the target trajectory generated by the action plan generation unit 140 on a scheduled time.

The second control unit 160 includes, for example, an acquisition unit 162, a speed control unit 164, and a steering control unit 166. The acquisition unit 162 acquires information regarding the target trajectory (trajectory points) generated by the action plan generation unit 140 and stores the information in a memory (not shown). The speed control unit 164 controls the travel driving power output device 200 or the brake device 210 based on a speed element incidental to the target trajectory stored in the memory. The steering control unit 166 controls the steering device 220 in accordance with a curve state of the target trajectory stored in the memory. Processes of the speed control unit 164 and the steering control unit 166 are realized, for example, by combining feed-forward control and feedback control. For example, the steering control unit 166 performs the feed-forward control in accordance with a curvature of a road in front of the own vehicle M and the feedback control based on separation from the target trajectory in combination.

The storage unit 192 is a storage device such as an HDD or a flash memory. The storage unit 192 stores information such as recovery information R regarding a method of recovering from an abnormal factor or display information D displayed on the display unit. The content will be described later.

The travel driving power output device 200 outputs a travel driving force (torque) for traveling the vehicle to a driving wheel. The travel driving power output device 200 includes, for example, a combination of an internal combustion engine, an electric motor and a transmission, and an ECU controlling these units. The ECU controls the foregoing configuration in accordance with information input from the second control unit 160 or information input from the driving operator 80.

The brake device 210 includes, for example, a brake caliper, a cylinder that transmits a hydraulic pressure to the brake caliper, an electronic motor that generates a hydraulic pressure to the cylinder, and a brake ECU. The brake ECU controls the electric motor in accordance with information input from the second control unit 160 or information input from the driving operator 80 such that a brake torque in accordance with a brake operation is output to each wheel. The brake device 210 may include a mechanism that transmits a hydraulic pressure generated in response to an operation of the brake pedal included in the driving operator 80 to the cylinder via a master cylinder as a backup. The brake device 210 is not limited to the above-described configuration and may be an electronic control type hydraulic brake device that controls an actuator in accordance with information input from the second control unit 160 such that a hydraulic pressure of the master cylinder is transmitted to the cylinder.

The steering device 220 includes, for example, a steering ECU and an electric motor. The electric motor works a force to, for example, a rack and pinion mechanism to change a direction of a steering wheel. The steering ECU drives the electric motor to change the direction of the steering wheel in accordance with information input from the second control unit 160 or information input from the driving operator 80.

### [Detection of Abnormal Factor]

In a case that the own vehicle M performing unmanned automatic driving is stopped due to any factor, it is preferable to quickly solve the state in which the own vehicle M is stopped and facilitate surrounding traffic. The automatic driving control device 100 performs assistance to remove the factor causing the own vehicle M to stop. The own vehicle M includes not only an unmanned automatic driving vehicle but also, for example, an automatic driving vehicle in a state in which an occupant who is sleeping may not be able to solve the stopping factor by himself or herself.

The vehicle state detection unit 132 detects an abnormal factor occurring the own vehicle M capable of performing self-diagnosis of the own vehicle M and performing automatic driving. The abnormal factor is a factor causing a trouble in travel of the own vehicle M. Examples of the abnormal factor include failures in a traveling device occurring in the travel driving power output device 200, the brake device 210, the steering device 220, and the like, failures in devices such as the brake lamp 97, a headlight, and an indicator, failures such as dirt or the like on the camera 10, the radar device 12, and the finder 14, and failures in devices necessary for travel of automatic driving of the navigation device 50 and the like.

For example, the vehicle state detection unit 132 monitors an output value of the monitoring sensor 45 and detects abnormality occurring in the own vehicle M. The monitoring sensor 45 outputs an output value during an operation of each device in association with an instruction value given to the device, for example, in a case that the own vehicle M is traveling or executing an operation of detecting predetermined abnormality. The monitoring sensor 45 outputs a detection result to the vehicle state detection unit 132. For example, the vehicle state detection unit 132 compares a predetermined threshold with an output value of the monitoring sensor 45 (hereinafter referred to as sensors) at each predetermined time or a predetermined timing and determines that abnormality occurs in the device in a case that a standard is not satisfied.

The predetermined timing is, for example, a time at which a load of a process of the automatic driving control device 100 is small, such as a timing at which the own vehicle M stops. The predetermined timing may be a timing at which collision is determined to occur in the own vehicle M based on the output value of the vehicle sensor 40. The vehicle state detection unit 132 may determine that abnormality occurs in a device in a case that correlation between the output value and the instruction value given to the device is out of the range of a normal state.

The vehicle state detection unit 132 further determines an abnormal level in a case that the vehicle state detection unit 132 determines that the abnormality occurs. For example, in a case that the camera 10 or the radar device 12 becomes dirty with mud or snow and the detection precision is lowered, the vehicle state detection unit 132 assigns an abnormal level in accordance with the lowering of detection precision Alternatively, in a case that there is correlation between a deterioration state of a certain sensor and a current value, the vehicle state detection unit 132 assigns a level to each sensor state in accordance with an output value of the monitoring sensor 45. The vehicle state detection unit 132 extracts countermeasures in accordance with the abnormal level from data stored in the storage unit 192.

The storage unit 192 stores information regarding the countermeasures for recovering from abnormal factors, for example, to correspond to abnormal factors detected by the own vehicle, in the own vehicle M. For example, the storage unit 192 stores recovery information R regarding a method of recovering from dirt caused due to mud or snow in the camera 10 or the radar device 12 in association with the dirt caused due to mud or snow in the camera 10 or the radar device 12, which is an example of the detected abnormal factor. The storage unit 192 stores display information D that is displayed on the display unit in a case that the own vehicle M is stopped due to an abnormal factor.

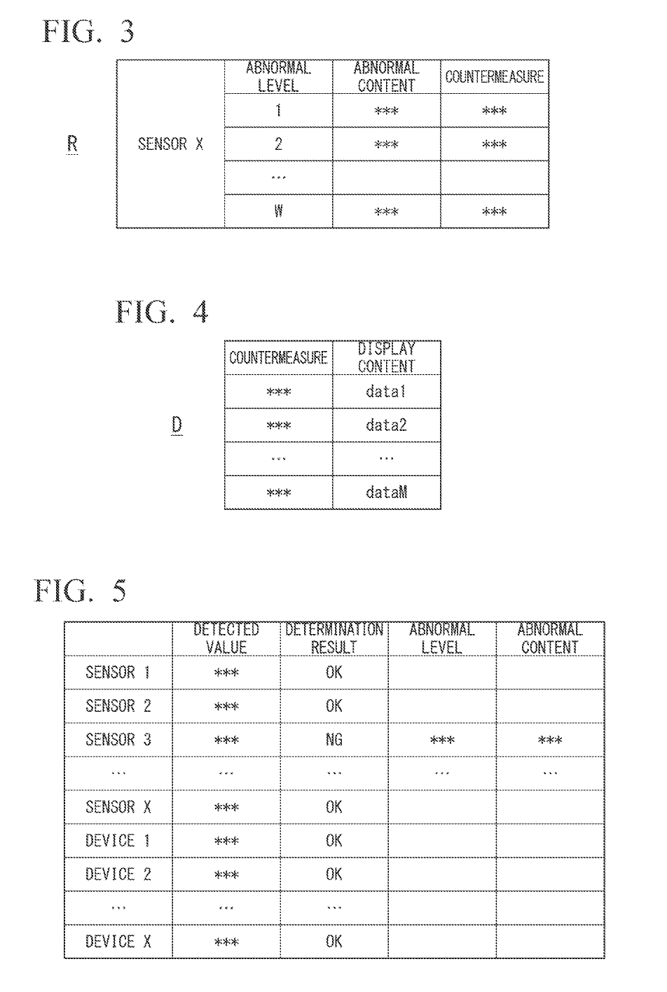

FIG. 3 is a diagram showing an example of content of recovery information R. The recovery information R is information in which an abnormal level in accordance with an output value of each of the sensors, abnormal content, and a countermeasure are associated with each other in a case that a predetermined standard is not satisfied. The predetermined standard will be described below. For example, in a case that an output value which does not satisfy a standard of a certain sensor X is in the range of a predetermined abnormal level set in advance, the abnormal level of the sensor X is determined. In a case that abnormal levels of the sensors are referred to in the recovery information R, abnormal content in accordance with the abnormal levels and countermeasures corresponding to the abnormal content can be obtained. The vehicle state detection unit 132 extracts the determined countermeasures associated with the abnormal levels of the sensors with reference to the recovery information R.

FIG. 4 is a diagram showing an example of content of the display information D displayed on the display unit during stopping of the own vehicle M. The display information D is information in which countermeasures against abnormality are associated with display content displayed on the display unit.

FIG. 5 is a diagram showing abnormality detected by the vehicle state detection unit 132. The vehicle state detection unit 132 compares detected values of the sensors and predetermined thresholds and determines whether abnormality occurs in the devices of the own vehicle M. The abnormality of the devices is determined in accordance with the thresholds set for the types of sensors or use purposes. The vehicle state detection unit 132 compares an output value of each of the sensors with the threshold and determines whether the output value satisfies a standard in accordance with the type of sensor (whether the output value is equal to or greater than the threshold, less than the threshold, in the range of a predetermined value, or out of the range of the predetermined value) to determine abnormality of each of the devices.

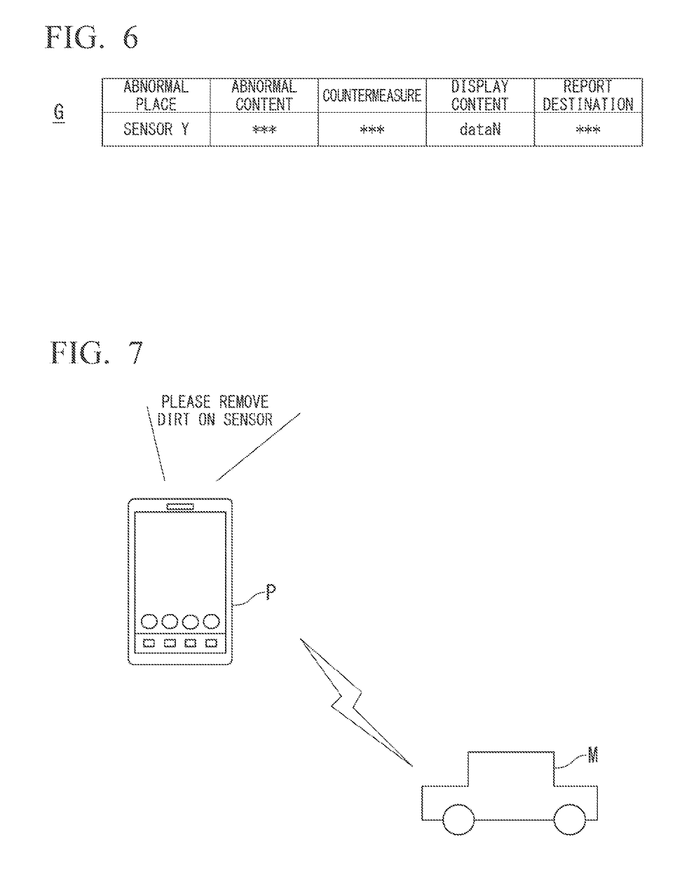

In a case that the output values of the sensors do not satisfy the standards, the vehicle state detection unit 132 decides that abnormality occurs in the devices and determines abnormality levels set in advance based on the output values of the sensors. FIG. 6 is a diagram showing an example of content of control information G generated by the vehicle state detection unit 132. The vehicle state detection unit 132 reads the recovery information R (see FIG. 3) and the display information D (see FIG. 4) from the storage unit 192 and generates the control information G The control information G is information in which an abnormal place, abnormal content, a countermeasure, display content, and a report destination are associated with each other. The vehicle state detection unit 132 extracts data of the display content in accordance with the extracted countermeasure with reference to the display information D and generates the control information G

The vehicle state detection unit 132 instructs the display control unit 180 based on the control information G to output information in accordance with content of the abnormal factor to the vehicle-exterior report unit 90. The vehicle state detection unit 132 instructs the communication control unit 190 based on the control information G to transmit information in accordance with content of the abnormal factor to the outside of the vehicle via the communication device 20.

The display control unit 180 reads, for example, data of the display content from the storage unit 192 with reference to the control information G For example, in a case that the countermeasure against the abnormal factor, such as removing dirt on the camera 10 or the radar device 12 or exchanging a spare tire, can be taken on the spot, the display control unit 180 outputs information for appealing resolution means such as “Please remove dirt on camera” or “Exchange tire” to a nearby person to the vehicle-exterior report unit 90. In a case that the countermeasure against the abnormal factor may not be taken on the spot, information indicating that the own vehicle M stands by until the abnormal factor such as “a request for repair” is solved is output to the vehicle-exterior report unit 90.

For example, in a case that the abnormal factor is a factor such as engine stop indicating that a repair is necessary with reference to the control information G, the communication control unit 190 transmits information regarding the abnormal factor to a predetermined organization such as a road service via the communication device 20 or sends a request to a wrecker. Then, the display control unit 180 outputs information such as “a request to a wrecker” is output to the vehicle-exterior report unit 90.

Not only is information supplied with a display image IM1 displayed on the vehicle-exterior display 92, but information regarding abnormality occurring in the own vehicle M may also be supplied to a terminal device which is around the own vehicle M.

The communication control unit 190 transmits the information regarding the abnormal factor occurring in the own vehicle M to a terminal device which is around the own vehicle M by using a cellular network, a Wi-Fi network, Bluetooth, or the like via the communication device 20 based on the control information G. A terminal device P may be a terminal device installed in another vehicle capable of performing inter-vehicle communication.

FIG. 7 is a diagram showing an example of content of a display image IM2 displayed on the terminal device P. For example, the terminal device P receives information indicating that abnormal factor occurs in the own vehicle M. For example, the display image IM2 is displayed on the terminal device P of a traffic participant around the own vehicle M. As the display image IM2, for example, resolution means such as “Remove dirt on camera” is displayed. The display image IM2 is displayed in tandem with an application related to traffic information such as a map or navigation executed in the terminal device P operating by communication.

In a case that the application related to the traffic information is executed in the terminal device P and a user carrying the terminal device P approaches the own vehicle M, the own vehicle M is displayed as a disabled vehicle which is stopping in the display image IM2 on the terminal device P. In addition to or instead of the display of the display image IM2, information regarding the stopping of the own vehicle M may be reported to the terminal device P by sound.

Thus, the automatic driving control device 100 can allow a third party such as a traffic participant around the own vehicle M to know a cause for stopping the own vehicle M and urges to the outside to remove the abnormal factor of the own vehicle. As described above, the information is reported to the terminal device P in tandem with the application related to the traffic information. However, in a case that the third party approaches the periphery of a door of the own vehicle M stopped due to abnormality, a scheme of removing the abnormal factor of the vehicle may be displayed on the terminal device P.

For example, in a case that the abnormal factor is a factor indicating that a repair is necessary with reference to the control information G, the communication control unit 190 transmits information regarding the abnormal factor to a predetermined organization such as a road service via the communication device 20 or sends a request to a wrecker. The communication control unit 190 may acquire information regarding a contact number of the predetermined organization with reference to the second map information 62 or from a network.

The communication control unit 190 may communicate with a server connected to the network and supply information to the server. For example, the communication control unit 190 supplies information to a service server set to supply information regarding the own vehicle to a third party. The service server is, for example, a server that is managed by a service provider that supplies traffic information. A user accesses the service server to obtain traffic information such as stopping of the own vehicle M in a case that the user browses the traffic information on a road used by him or her. For example, the service server may supply a service related to traffic information such as maps or navigation online or may supply information such as stopping of the own vehicle M in tandem with a service.

The communication control unit 190 may access an information supply server set to supply countermeasure information against abnormal factors occurring in the own vehicle M to receive information necessary for emergency treatment or the like. The information supply server supplies countermeasures to the own vehicle M based on information regarding failure content transmitted by the communication control unit 190.

In a case that the own vehicle M receives information regarding the countermeasure from the information supply server, the own vehicle M causes the HMI 30 to display the information.

The information supply server may further allows a person around the own vehicle M to make contact and talk with an operator. The own vehicle M may display information on the vehicle-exterior display 92 through a remote operation by the operator or receive a troubleshooting of software or the like through a remote operation by the operator.

In a case that an abnormal factor of the own vehicle M is solved through emergency treatment or the like or it is recognized that a failure handling person of a wrecker, police, a fire station, or the like arrives, the display control unit 180 stops supplying information. For example, the fact that the failure handling person arrives may be recognized by the recognition unit 130 or may be recognized based on arrival information regarding the arrival of the failure handling person acquired via the communication device 20.

### [Process Flow]

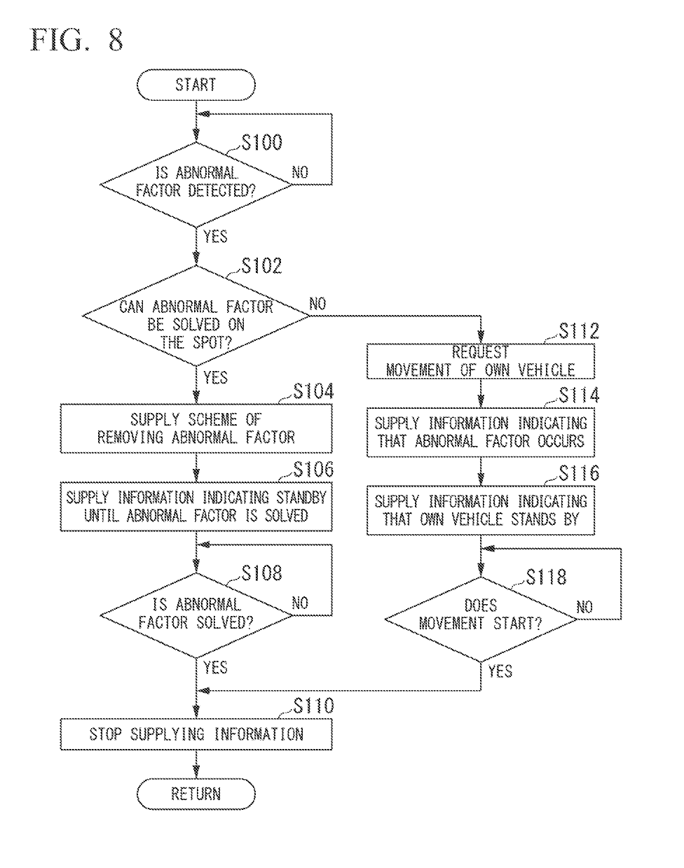

Next, a flow of a process executed by the automatic driving control device 100 will be described. FIG. 8 is a flowchart showing an example of the flow of the process performed in the automatic driving control device 100. Based on a detection result of the monitoring sensor 45, the vehicle state detection unit 132 determines whether an abnormal factor is detected in each device of the own vehicle M (step S100). In a case that the determination is negative in step S100, the vehicle state detection unit 132 repeats the determination process at a predetermined interval or a predetermined timing.

Subsequently, the vehicle state detection unit 132 determines whether the detected abnormal factor can be solved in a place in which the own vehicle is located or its nearby region (step S102). In a case that the determination is positive in step S102, the display control unit 180 displays a scheme of removing the abnormal factor of the own vehicle M on the vehicle-exterior display 92 (step S104). At this time, the communication control unit 190 transmits information regarding the abnormal factor of the own vehicle M to a terminal device around the own vehicle M or a server on a network and reports the information to a predetermined organization as necessary.

Subsequently, the display control unit 180 displays information indicating standby until the abnormal factor of the own vehicle M is solved on the vehicle-exterior display 92 (step S106). The automatic driving control device 100 stands by until the abnormal factor of the own vehicle is solved through assistance of a third party. The vehicle state detection unit 132 determines whether the abnormal factor of the own vehicle M is solved (step S108). In a case that the determination is negative in step S108, the vehicle state detection unit 132 repeats the determination process. In a case that the determination is positive in step S108, the display control unit 180 stops the display of the vehicle-exterior display 92 (step S110).

In a case that the determination is negative in step S102, the communication control unit 190 requests movement of the own vehicle M to a road service or the like (step S112). The display control unit 180 displays information indicating that an abnormal factor occurs on the vehicle-exterior display 92 (step S114). Subsequently, the display control unit 180 displays information indicating standby until a person or the like that moves the own vehicle M arrives on the vehicle-exterior display 92 (step S116).

Based on a recognition result of the recognition unit 130, the vehicle state detection unit 132 determines whether the own vehicle M is moved (step S118). In a case that the determination is negative in step S118, the vehicle state detection unit 132 repeats the determination process. In a case that the determination is positive in step S118, the process returns to step S110. Thereafter, the process of the flowchart ends. Each of the foregoing steps can be appropriately switched.

According to the above-described embodiment, the automatic driving control device 100 can request assistance to solve the stopped state in a case that the automatic driving vehicle stops due to any factor. The automatic driving control device 100 can send a request for removing abnormality occurring in the own vehicle to a traffic participant around the own vehicle to remove the abnormality by displaying predetermined information on the stopped automatic driving vehicle, so that traffic can be facilitated. The automatic driving control device 100 can supply information regarding an own vehicle state to a third party by transmitting information regarding an abnormal factor occurring in the own vehicle to a server.

### [Hardware Configuration]

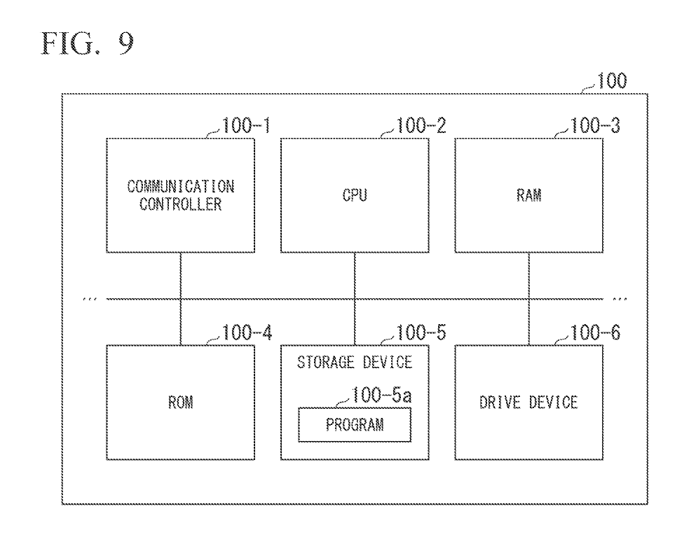

FIG. 9 is a diagram showing an example of a hardware configuration of the automatic driving control device 100 according to the embodiment. As shown, the automatic driving control device 100 is configured such that a communication controller 100-1, a CPU 100-2, a random access memory (RAM) 100-3 that is used as a working memory, a read-only memory (ROM) 100-4 that stores a boot program or the like, a storage device 100-5 such as a flash memory or a hard disk drive (HDD), a drive device 100-6, and the like are connected to each other via an internal bus or a dedicated communication line.

The communication controller 100-1 performs communication with a constituent element other than the automatic driving control device 100. The storage device 100-5 stores a program 100-5a that is executed by the CPU 100-2. The program is loaded on the RAM 100-3 by a direct memory access (DMA) controller (not shown) to be executed by the CPU 100-2.

Thus, some or all of the vehicle state detection unit, self-running possibility determination unit, the driving control unit, the display control unit, and the communication control unit are realized.

The above-described embodiment can be expressed as follows:

a vehicle control device including a storage device that stores a program and a hardware processor,

wherein the hardware processor executes the program stored in the storage device to detect an abnormal factor occurring in an own vehicle capable of performing automatic driving so as to supply information for recovering the own vehicle from the abnormal factor to the outside of the own vehicle in a case that the own vehicle stops due to the abnormal factor detected by the own vehicle.

While preferred embodiments of the invention have been described and shown above, it should be understood that these are exemplary of the invention and are not to be considered as limiting. Additions, omissions, substitutions, and other modifications can be made without departing from the spirit or scope of the present invention.

Accordingly, the invention is not to be considered as being limited by the foregoing description, and is only limited by the scope of the appended claims.

What is claimed is:

1. A vehicle control device comprising:
a detection unit that is configured to detect an abnormal factor occurring in an own vehicle capable of performing automatic driving; and
a control unit that is configured to supply information for recovering the own vehicle from the abnormal factor to an outside of the own vehicle in a case that the own vehicle stops due to the abnormal factor detected by the detection unit.

2. The vehicle control device according to claim 1, wherein the control unit stops supplying the information in a case that the abnormal factor is solved.

3. The vehicle control device according to claim 1, wherein the control unit supplies the information to a terminal device around the own vehicle via a communication unit.

4. The vehicle control device according to claim 1, wherein the control unit communicates with a server set to supply the information of the own vehicle to a third party via a communication unit and supplies the information to the server.

5. The vehicle control device according to claim 1, wherein the control unit communicates with a server set to supply countermeasure information for the abnormal factor occurring in the own vehicle via a communication unit and supplies the countermeasure information to the server.

6. The vehicle control device according to claim 1, wherein the control unit supplies the information using a display unit that displays information to a periphery of the own vehicle.

7. The vehicle control device according to claim 1, wherein the own vehicle is an unmanned automatic driving vehicle.

8. A vehicle control method performed by a computer mounted on a vehicle control device, the method comprising: by the vehicle control device,
detecting an abnormal factor occurring in an own vehicle capable of performing automatic driving; and
supplying information for recovering the own vehicle from the abnormal factor to an outside of the own vehicle in a case that the own vehicle stops due to the abnormal factor detected by the vehicle control device.

9. A computer-readable non-transitory storage medium storing a program and causing a computer mounted on a vehicle control device to perform:
detecting an abnormal factor occurring in an own vehicle capable of performing automatic driving; and
supplying information for recovering the own vehicle from the abnormal factor to an outside of the own vehicle in a case that the own vehicle stops due to the abnormal factor detected by the vehicle control device.
